(19) United States
(12) Patent Application Publication
(10) Pub. No.: US 2023/0145796 A1
(43) Pub. Date: May 11, 2023

(54) RESIDENTIAL HYBRID HOT WATER TANK AND CONTROL SYSTEM THEREFOR

(71) Applicant: FLEXCHANGER TECHNOLOGIES INC., Vancouver (CA)

(72) Inventors: Walter WARDROP, Vancouver, BC (CA); Nicholas BARBER, Vancouver, BC (CA); George LIU, Vancouver, BC (CA)

(73) Assignee: FLEXCHANGER TECHNOLOGIES INC., Vancouver, BC (CA)

(21) Appl. No.: 17/906,736

(22) PCT Filed: Mar. 18, 2021
(86) PCT No.: PCT/CA2021/050363

§ 371 Date: Sep. 19, 2022

(30) Foreign Application Priority Data
Mar. 18, 2020 (CA) 3076404

(51) Int. Cl. F24H 15/16; F24H 1/18; F24H 15/208; F24H 15/238; G05B 19/4155

(52) U.S. Cl. CPC F24H 15/16; F24H 1/185; F24H 1/186; F24H 15/208; F24H 15/238; G05B 19/4155; G05B 2219/50333

(57) ABSTRACT

A hot water tank is provided. The hot water tank comprising: a tank which includes a bottom, a top, and sides therebetween to define an interior; a combustion chamber within the interior, proximate the bottom and sides, the combustion chamber terminating in a mouth where it connects to the side; a gas burner, which is a first heat source and is housed in the combustion chamber; a combustion fan located at the mouth of the combustion chamber and in gaseous communication with an ambient environment and the combustion chamber; a substantially spiral flue which extends upward through the interior and is in gaseous communication with the combustion chamber and a chimney, which is located proximate the top of the tank, such that in use flue gases travel from the combustion chamber upward to the chimney; a condensation trap, which is outside the tank and is in fluid communication with the combustion chamber or the flue proximate the combustion chamber; and a controller, the controller configured to control the burner.

### FIELD

The present technology is related to a hot water tank that is heated by one or more of electricity and natural gas. More specifically, it is a hot water tank that includes a spiral chimney which is housed within the tank.

### BACKGROUND

Heating hot water for residential use is not terribly energy efficient. For example, the EnergyStar site puts average hot water storage tank efficiency at about 67%, with a range from as low as 60% to a high of 72%. For this reason, there have been many attempts to improve the efficiency. Many technologies have focused on using heat pump water heaters. For example, U.S. Pat. No. 9,845,978 discloses a heat pump water heater and systems and methods for its control. The systems are configured to heat water within a water storage tank of a heat pump water heater wherein a controller within the system is operatively connected to a plurality of heat sources including at least one electric heating element and a heat pump and sensors in order to selectively energize one of the plurality of heat sources. The controller is configured to process data representative of the temperature of water within the tank near the top of the water storage tank, and rate of water flowing out of the water storage tank, in order to automatically selectively energize the heat sources. The selection of heat sources by the controller is determined by a mode of operation selected by the user and the data processed by the controller in view of the selected mode of operation. This does not allow for selecting between natural gas and electricity or using both. As natural gas is not used, there is no means for optimizing heat extraction from the power source.

U.S. Pat. No. 9,684,358 discloses an electrical appliance that includes a communication unit receiving energy related information from the outside; a control unit receiving the energy related information from the communication unit; an energy consumption component operating by the control unit; and an input unit receiving a command for selecting an operation mode of the energy consumption component. The operation mode of the energy consumption component includes a first power saving mode in which the operation of the energy consumption component is restricted on a basis of the energy related information, and a second power saving mode in which the operation of the energy consumption component is restricted irrespective of the energy related information. One of the first and second power saving modes is selected through the input unit. This does not allow for selecting between natural gas and electricity or using both. As natural gas is not used, there is no means for optimizing heat extraction from the power source.

United States Patent Application 20180356125 discloses a water heating apparatus that includes a water inlet port and a hot water supply connection water outlet port. A burner assembly includes a burner disposed within a combustion chamber housing. At least two heat exchangers are operated in parallel. At least two of the at least two heat exchangers have at least a first heat exchanger water inlet port on a same side of the water heating apparatus. A water jacket is defined by an area between an outer containment vessel and the combustion chamber housing. The heated water flows out of each of each of the at least two heat exchangers through the portion of each of the at least two heat exchangers into the water jacket. The heated water which flows into the water jacket is further heated by the combustion chamber housing and the further heated water exits the water heating apparatus at the hot water supply connection water outlet port. This does not allow for selecting between natural gas and electricity or using both.

United States Patent Application 20170219220 discloses a water heating system for a domestic hot water tank, the system including: a heat pump adapted to provide heat energy; and a heat exchanger comprising a coil of thermally conductive material arranged such that a diameter of the coil is approximately between five and six times greater than a diameter of the thermally conductive material and the heat exchanger is adapted to be installed in the domestic hot water tank and operationally coupled to the heat pump. This does not allow for selecting between natural gas and electricity or using both. As natural gas is not used, there is no means for optimizing heat extraction from the power source.

United States Patent Application 20170010021 discloses an integrated heat exchanger and burner assembly in which the combustion occurs proximate the surface of the heat exchanger. Such a system may include at least one tube that is coiled into a number of turns, that is a tube coil with the at least one tube having an inlet and an outlet and the distance between adjacent turns is less than a predetermined distance. The tube coil has water flowing through it and is heated by the combustor. This requires that the system is a flow through system, thus it is not an efficient hot water storage system. This does not allow for selecting between natural gas and electricity or using both.

Other approaches attempt to extract as much heat as possible through surface area interactions. In many hot water tanks, combustion gases pass up through a central flue, exchanging heat with the wall of the flue and with the water contained within the water tank. It has long been known that internal baffles within the central flue can increase heat transfer between the flue gases and the water within the water tank. The baffles perform three basic functions. First, the baffles slow the passage of the combustion gases through the flue, giving more time for heat transfer between the gases and the flue wall. Second, the baffles mix the combustion gases within the flue, bringing more of the flue gases into contact with the flue wall which transfers heat to the water. Third, the baffles conduct heat to the wall of the flue.

United States Patent Application 20030155430 discloses a heater that comprises an enhanced-surface area heat transfer vessel which is situated co-axially in a hot flue gas plenum. The plenum is formed by dual-wall heating jacket. Liquid flowing through the jacket is heated co-currently by the flue gas before the preheated liquid is conducted to the top of the vessel for countercurrent heat exchange therein before discharge from the bottom of the vessel. Hot flue gas flowing through the plenum is directed circumferentially by one or more spaced and perforated ring plates placed across the plenum annulus between the jacket and the vessel. Aluminum construction of the vessel and jacket with protective coatings contribute to a lightweight heater for either floor or even wall mounting. The heater is conveniently implemented in a hydronic heating system, a potable hot water system or a combination of both. This does not allow for selecting between natural gas and electricity or using both.

United States Patent Application 20190323762 discloses a refrigerator that may include a cabinet to define a storage space, a door to open and close the storage space, a dispenser provided in the door to dispense hot water, a hot water tank through which water flows so as to heat water introduced into the door, a heater provided in the door to heat the hot water tank, a water inflow passage through which water is supplied to the hot water tank, a water discharge passage guiding hot water discharged from the hot water tank to the dispenser, a flow rate sensor provided in the water inflow passage to measure a flow rate of water flowing through the water inflow passage, a water inflow valve provided in the water inflow passage to adjust a flow of water in the water inflow passage, a water discharge valve provided in the water outlet passage, an input provided in the door to input a temperature of the hot water to be dispensed and a hot water dispensing command, and a controller to control the water inflow valve and the water discharge valve. A coil around the outside of the hot water tank may be used to heat the water. The coil is configured for induction heating of the water hence it is an electrical coil. This does not allow for selecting between natural gas and electricity or using both. As natural gas is not used, there is no means for optimizing heat extraction from the power source.

U.S. Pat. No. 7,836,856 discloses that a water heater has a burner positioned below a vertical centrally located flue with heat exchange capacity enhanced by a multiplicity of rectangular metal fins which are welded on the inside of the vertical central flue. The central flue extends upwardly within a water tank. The central flue transitions to a smaller diameter downwardly draining helically coiled condensing flue. Approximately 80% of the heat from the combustion gases is transferred to the water within the water tank through the wall of the central flue without condensation. An additional 10% or more of the combustion heat is transferred to the water accompanied by condensation of water in the coiled flue. A fan draws the combustion gases through the central flue and the coiled condensing flue and supplies the combustion gases to an exterior vent. The application discloses that a large central flue combined with a relatively short helical condensing flue is needed to minimize the inherent higher resistance of a narrower and longer helical flue. Thus, the design is more complex that need be. There is no structure to stop cold air from entering the building through the flue. Further, it does not allow for selecting between natural gas and electricity or using both.

U.S. Pat. No. 4,766,883 discloses a high efficiency forced draft water and space heater that maintains a desired air to fuel ratio and efficiency in combustion regardless of changes in air inlet pressure. The heater uses a venturi type proportioner and associated fuel regulator to provide an air and fuel mixture of constant ratio which is drawn from the proportioner by a blower and introduced into a closed combustion chamber for efficient burning and heating of a surrounding body of water. A wide, vertical flue extends upward in the tank and is in gaseous communication with a helical segment that spirals downwardly within the water tank. There is no structure to stop cold air from entering the building through the flue. Further, it does not allow for selecting between natural gas and electricity or using both.

What is needed is a hybrid hot water tank in which the power source can be one or more of natural gas and electricity. It would be preferable if the controller allowed for hot water to be dispensed without heating the replacement water immediately. It would be further preferable if the flue was a spiral to allow for more heat extraction from the flue gases. It would be preferable if the flue design further included a flue fan which also acted as a shutter when not in use. It would be further preferable if the modulation and selection of heat source was automatic and therefore required no human intervention. It would be further preferable if the controller was remote or was remotely controlled. It would be highly advantageous if the utility could request and modulate the heat source.

### SUMMARY

The present technology is a hybrid hot water tank in which the power source can be one or more of natural gas and electricity. The controller allows for hot water to be dispensed without heating the replacement water immediately. The flue is a spiral to allow for more heat extraction from the flue gases. The flue design further includes a flue fan which also acted as a shutter when not in use, thereby restricting or eliminating gravity feed of cold outside air into the house. The selection of the heat source and the modulation of the heat source is automatic and therefore requires no human intervention. The controller can be locally or remotely controlled. The utility is able to request and modulate the power source.

In one embodiment a hot water tank is provided, the hot water tank comprising: a tank which includes a bottom, a top, and sides therebetween to define an interior; a combustion chamber within the interior, proximate the bottom and sides, the combustion chamber terminating in a mouth where it connects to the side; a gas burner, which is a first heat source and is housed in the combustion chamber; a combustion fan located at the mouth of the combustion chamber and in gaseous communication with an ambient environment and the combustion chamber; a substantially spiral flue which extends upward through the interior and is in gaseous communication with the combustion chamber and a chimney, which is located proximate the top of the tank, such that in use flue gases travel from the combustion chamber upward to the chimney; a condensation trap, which is outside the tank and is in fluid communication with the combustion chamber or the flue proximate the combustion chamber; and a controller, the controller configured to control the burner.

The hot water tank may further comprise at least one electrical element which is a second heat source and is housed in the interior and is under control of the controller.

The hot water tank may further comprise a thermostat and a temperature sensor, the thermostat and temperature sensor in electronic communication with the controller.

In the hot water tank, the controller may include a processor and a memory, the memory configured to modulate the first heat source and the second heat source based on parameters including one or more of a target temperature, a selected rate of heating, a current system load, a cost of a heat source and an availability of the heat source.

In the hot water tank, the processor may be configured to switch the first heat source on and off, switch the second heat source on and off and adjust an output of each of the first heat source and the second heat source.

In the hot water tank, the spiral flue may have an inside diameter of about 2 inches.

In the hot water tank, a surface area of the spiral flue to a volume of the tank may have a ratio of about 0.09 to about 0.3.

In the hot water tank, a volume of the spiral flue to a volume of the tank may have a ratio of about 0.05 to about 0.057.

In another embodiment, a hybrid residential water heating system is provided, the system comprising:
a hot water tank which includes a bottom, a top, and sides therebetween to define an interior; a combustion chamber within the interior, proximate the bottom and sides, the combustion chamber terminating in a mouth where it connects to the side; a gas burner, which is a first heat source and is housed in the combustion chamber; a combustion fan located at the mouth of the combustion chamber and in gaseous communication with an ambient environment and the combustion chamber; a spiral flue which extends through the interior and is in gaseous communication with the combustion chamber and a chimney, which is located proximate the top of the tank, such that in use, flue gases travel from the combustion chamber upward to the chimney; a condensation trap, which is outside the tank and is in fluid communication with the combustion chamber or the flue proximate the combustion chamber; at least one electrical element which is a second heat source and is housed in the interior; a thermostat and a temperature sensor, the thermostat and temperature sensor; and
a controller which includes a printed circuit board printed and a microprocessor. wherein the microprocessor is configured to modulate the first heat source and the second heat source and is in electronic communication with the thermostat and the temperature sensor.

In the hybrid residential water heating system, one or more of the printed circuit board and the microprocessor may include a wired link or a wireless link.

The hybrid hot water tank system may further comprise a computing device which includes a wired link or a wireless link and is remote to the hot water tank, the printed circuit board and the microprocessor.

In the hybrid residential water heating system, the computing device may be a utilities company computing device.

In the hybrid residential water heating system, the computing device may be a third-party systems management company computing device.

In the hybrid residential water heating system, the computing device may include a memory and a processor, the memory configured to instruct the processor to instruct the microprocessor to modulate the first heat source and the second heat source based on parameters including one or more of the target temperature, the selected rate of heating, the current system load, the cost of a heat source and the availability of the heat source.

In the hybrid residential water heating system, the computing device memory is further configured to instruct the processor to determine a cost-effective heating mode and to instruct the microprocessor to modulate the first heat source and the second heat source based on the cost-effective heating mode.

In the hybrid residential water heating system, the spiral flue may have an inside diameter of about 2 inches.

In the hybrid residential water heating system, a surface area of the spiral flue to a volume of the hot water tank may have a ratio of about 0.09 to about 0.3.

In the hybrid residential water heating system, a volume of the spiral flue to a volume of the hot water tank may have a ratio of about 0.05 to about 0.057.

In another embodiment, a method of heating a domestic water supply is provided, the method comprising:
selecting the hybrid residential water heating system as described above; and
modulating the first heat source and the second heat source with the microprocessor based on parameters including a target temperature, a selected rate of heating, a current system load, a cost of a heat source and an availability of the heat source by adjusting a gas flow and an electric current flow.

The method may further comprise the microprocessor, in any order and in any number of times, switching the first heat source on and off, switching the second heat source on and off and adjusting an output of each of the first heat source and the second heat source.

The method may further comprise the microprocessor communicating with a remote computing device.

The method may further comprise the remote computing device instructing the microprocessor to modulate the first heat source and the second heat source based on parameters including one or more of the target temperature, the selected rate of heating, the current system load, the cost of a heat source and the availability of the heat source.

The method may further comprise the remote computing device determining a cost-effective heating mode and instructing the microprocessor, the microprocessor adjusting the gas flow and the electric current flow such that the first heat source and the second heat source are operating in the cost-effective heating mode.

In another embodiment, a method of heating a domestic water supply is provided, the method comprising:
employing hybrid residential water heating system comprising: a hot water tank with a gas burner as a first heat source and an electric element as a second heat source; and a microprocessor which controls a gas flow and an electrical current flow; and
the microcontroller modulating the first heat source and the second heat source based on parameters including a target temperature, a selected rate of heating, a current system load, a cost of a heat source and an availability of the heat source by adjusting the gas flow and the electric current flow.

The method may further comprise the microprocessor, in any order and in any number of times, switching the first heat source on and off, switching the second heat source on and off and adjusting an output of each of the first heat source and the second heat source.

The method may further comprise the microprocessor communicating with a remote computing device.

The method may further comprise the remote computing device instructing the microprocessor to modulate the first heat source and the second heat source based on parameters including one or more of the target temperature, the selected rate of heating, the current system load, the cost of a heat source and the availability of the heat source.

The method may further comprise the remote computing device determining a cost-effective heating mode and instructing the microprocessor, the microprocessor adjusting the gas flow and the electric current flow such that the first heat source and the second heat source are operating in the cost-effective heating mode.

In another embodiment, a hybrid hot water tank is provided, the hybrid hot water tank comprising: a tank which includes a bottom, a top, and sides therebetween to define an interior; a combustion chamber within the interior, proximate the bottom and sides, the combustion chamber terminating in a mouth where it connects to the side; a gas burner, which is a first heat source and is housed in the combustion chamber; a combustion fan located at the mouth of the combustion chamber and in gaseous communication with an ambient environment and the combustion chamber; a substantially spiral flue which extends through the interior and is in gaseous communication with the combustion chamber and an externally disposed chimney; a condensation trap, which is outside the tank and is in fluid communication with the combustion chamber or the flue; a controller, the controller configured to control the burner; and at least one electrical element which is a second heat source and is housed in the interior and is under control of the controller, wherein the controller includes a processor and a memory, the memory configured to modulate the first heat source and the second heat source based on parameters including one or more of a target temperature, a selected rate of heating, a current system load, a cost of a heat source and an availability of the heat source.

In the hybrid hot water tank, the processor may be configured to switch the first heat source on and off, switch the second heat source on and off and adjust an output of each of the first heat source and the second heat source.

In the hybrid hot water tank the spiral flue may have an inside diameter of about 2 inches.

In the hybrid hot water tank, a surface area of the spiral flue to a volume of the tank may have a ratio of about 0.09 to about 0.3.

In the hybrid hot water tank, a volume of the spiral flue to a volume of the tank may have a ratio of about 0.05 to about 0.057.

### FIGURES

FIG. 1A is a schematic sectional view of the hot water tank of the present technology; FIG. 1B is an alternative embodiment of the condensation trap of the hot water tank of FIG. 1A.

FIG. 2 is a schematic sectional view showing the details of the combustion chamber, combustion fan and condensation trap.

FIG. 3 is a schematic sectional view of an alternative embodiment of FIGS. 1A and 1B.

FIG. 4 is a schematic sectional view of another alternative embodiment of FIGS. 1A and 1B.

FIG. 5 is a schematic of the flame ionization sensing system of the hot water tank of FIGS. 1A, 1B, 3 and 4.

FIG. 6 is a schematic of the gas control system of the hot water tank of FIGS. 1A, 1B, 3 and 4.

FIG. 7 is a schematic of the electricity control system of the hot water tank of FIGS. 1A, 1B, 3 and 4.

FIG. 8 is block diagram of autonomous operation of the hot water tank of FIGS. 1A, 1B, 3 and 4.

FIG. 9 is a block diagram of a utilities-controlled operation of the hot water tank of FIGS. 1A, 1B, 3 and 4.

FIG. 10 is a block diagram of the decision-making process for operating the hot water tank of FIGS. 1A, 1B, 3 and 4.

FIG. 11 is another alternative embodiment of FIGS. 1A and 1B.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

Definitions:

Heat source—in the context of the present technology, a heat source is an electrical power source or a gas source such as propane or natural gas.

First heat source and second heat source—in the context of the present technology, the use of “first” and “second” is interchangeable and is used simply to indicate that there is one heat source and there is another heat source.

Long flue—in the context of the present technology, a long flue is at least about twenty feet long and up to as long as about fifty feet long and all dimensions therebetween. The inside diameter is between about 1 inch inside diameter to about 2 inches inside diameter.

Substantially spiral flue—in the context of the present technology, a substantially spiral flue is one that is at least about 90% spiral, but may have one or more of a short section of horizontally disposed flue, a short section of vertically disposed flue and a short section of sloped flue.

### DETAILED DESCRIPTION:

The usage ratio between fuel sources (gas and electricity), may be influenced directly, or indirectly by the occupant, a building management system (BMS), a third party energy management service, or via the utility provider(s), in order to increase operational efficiency, to lower operating costs, and/or to provide building or district wide load management capabilities.

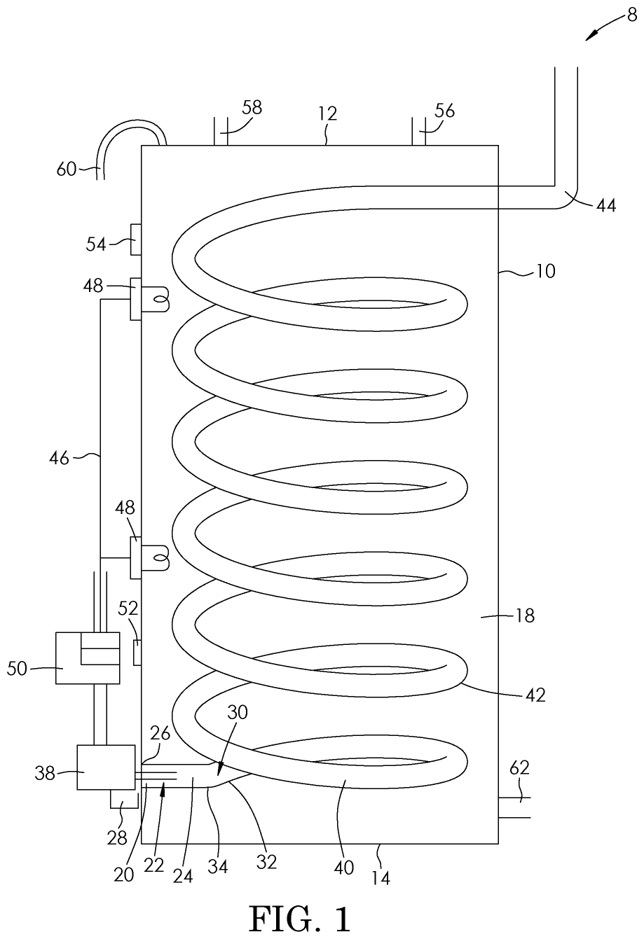

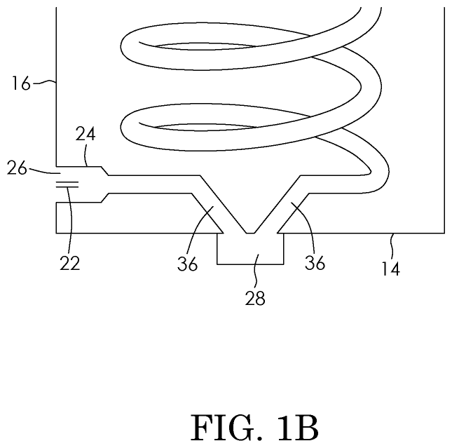

A hybrid hot water tank, generally referred to as 8 is shown in FIG. 1A. The tank 10 has a top 12, a bottom 14, and a cylindrical side wall 16, all which define an interior 18. A gas line 20, which may carry natural gas or propane or the like, provides fuel to a burner 22. The burner 22 is housed in a combustion chamber 24 which is in the vicinity of the bottom 14 of the tank 10. Below the combustion chamber 24, outside of the tank and in fluid communication with the combustion chamber 24 is a condensation trap 28. The combustion chamber 24 has a condensation collection zone, generally referred to as 30, which is defined by a sloping end 32 and a base 34. In an alternative embodiment, shown in FIG. 1B the condensation collection zone 30 is defined by two flue sections members 36, both which slope downward towards the condensation trap 28, which is below the bottom 14. The condensation trap 28 may be extended via a pipe to the floor pan. A combustion fan 38 is located proximate the burner 22 to provide combustion air from the ambient to the burner 22. The combustion fan 38 is in gaseous communication with the combustion chamber 24 and is located at the combustion chamber mouth 26. The combustion chamber 24 is in gaseous communication with the flue 40. Thus, when the combustion fan 38 is operational, it forces air into the combustion chamber 24 and urges the flue gases through the flue 40. The placement and pushing the flue gases rather than pulling them reduces the chance of condensation within the flue 40. The combustion fan 38 acts as a shutter, thus when it is not operational, it covers the combustion chamber mouth 26 and reduces or eliminates gravity feed of cold, outside air into the building in which the hot water tank 8 is housed. The combustion chamber 24 is shown extending into the interior 18 from the side wall 16 in this embodiment. In an alternative embodiment it is located on the bottom 14.

The flue 40 is formed into a spiral 42 (helical coil, helix) which extends from the combustion chamber 24 up through the interior 18 of the tank 10, reaching a chimney 44 at or proximate the top 12. There is no vertically disposed flue, nor is there vertically disposed combustion chamber 24 extending substantially into the interior. Heat from combustion is primarily extracted from the flue 40 as it is urged upward through the spiral flue 40 to the chimney 44. We need to be careful because the prior art can be construed as having a combustion chamber with a spiral flue extending from the bottom to the top of the interior (even though the flue gases go from the top to the bottom rather than the bottom to the top). The prior art has a large chamber centrally located in the interior with the burner below.

An electrical line 46 provides power to one or more electrical elements 48 which are housed in the interior 18. The electrical elements 48 are preferably located on the side wall 16 and are spaced apart from one another such that different zones of water in the interior are being heated at the same time, or different times.

A smart controller 50 is in electronic communication with the burner 22, the combustion fan 38, the electrical elements 48, a temperature sensor 52 and a thermostat 54.

Water enters the hot water tank 10 through an inlet 56 in the top 12 of the tank 10. Hot water leaves the tank 10 through an outlet 58 in the top 12 of the hot water tank 10. A safety valve 60 is also located in the top 12 of the tank 10. A drain 62 is located either in the bottom 14 or proximate the bottom 14 of the tank 10.

The flue 40 is about 2 inches in inside diameter. This is half the diameter of a standard flue, thus the surface area per inch of length of flue 40 is 12.57 square inches versus 37.7 square inches, however, the ratio of surface area to volume per inch of length of flue is about 4 for the flue 40 compared to about 3 for a standard flue. The flue 40 is about 38 feet long as compared to 4 feet long, hence the ratio of surface area to volume is about 2 for the flue 40 versus about 1 for a standard flue. This greatly increases the efficiency of heat transfer between the flue gases and the water in the interior 18 of the tank 10. As the spiral 42 does not conform to the golden ratio, the flue gases have an increased tendency to cavitate and be slowed, thus further increasing the efficiency of heat transfer between the flue gases and the water in the interior 18 of the hot water tank 10. Similarly, as the spiral 42 is not a straight flue, and gases tend to travel in a straight line, the flue gases contact the inner surface of the flue 40 more often, thus increasing the potential for heat transfer.

Table 1 shows a range of exemplary dimensions of the tank and the flue (note that the tank volume is calculate as the tank volume minus the volume of the flue.

| flue | | | | | coil | spiral | tank | | |
|---|---|---|---|---|---|---|---|---|---|
| inside | flue | spiral | | | outside | surface area | inside | tank | tank |
| diameter | length | height | | pitch | diameter | (square | diameter | height | volume |
| (inches) | (feet) | (inches) | coils | (inches) | (inches) | feet) | (inches) | (inches) | (gallons) |
| 1 | 40 | 30 | 14 | 2 | 10 | 10.5 | 16 | 36 | 32 |
| 1.25 | 40 | 40 | 15 | 2.5 | 12 | 13.1 | 18 | 48 | 53 |
| 1.5 | 40 | 45 | 14 | 3 | 14 | 15.7 | 20 | 50 | 68 |
| 1.75 | 40 | 52 | 14 | 3.5 | 16 | 18.3 | 22 | 60 | 99 |
| 2 | 40 | 60 | 14 | 4 | 18 | 20.9 | 23 | 65 | 117 |

The outside diameter of a coil of the spiral flue to a tank inside diameter has a ratio of about 0.6 to about 0.8. The ratio of spiral height to tank height may range from about 0.8 to about 0.95. The volume of the spiral flue to a volume of the hot water tank may have a ratio of about 0.05 to about 0.057. In comparison, the ratio of volume of a four foot long straight flue with an inside diameter of 4 inches to a volume of the hot water tank of 53 gallons is about 0.049. The surface area to tank volume ratio for a 1.25 inside diameter flue and a 53 gallons tank is about 0.15 versus 0.05 for the four foot straight flue with a diameter of 4 inches. The ratio of surface area to volume (gallons) for the spiral flues ranges from about 0.11 to about 0.21 and may range from about 0.09 to about 0.3. As would be known to one skilled in the art, as the length of the flue increases, one or more of the pitch decreases and the number of coils increases.

The controller 50 provides the following functionality:
A—heating quickly with natural gas (high BTU input) 40K Btu
B—heating slowly with natural gas 20K Btu
C—heating quickly with electricity (2×4500 watt=40K Btu)
D—heating slowly with electricity 0-20K Btu
E—heating twice as fast with both electricity and natural gas running at same time 80K Btu
F—overheating tank to store (usually done at night with cheap electricity)
G—Allowing hot water to leave tank without replacing it, using either energy source
H—vacation turndown, and turn on from Wi-Fi
I—Safety mode where temperature kept below 130° F. if no mixing valve available.

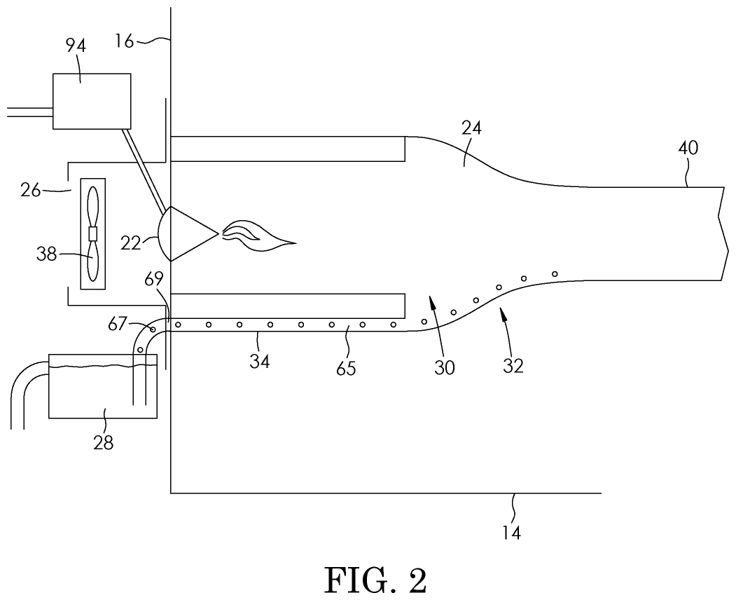

FIG. 2 is a close-up view of the burner 22, fan 38 and trap 28. The burner 22 is housed in the combustion chamber 24. The combustion chamber 24 is lined with a ceramic liner 64. A condensate channel 65 is defined by the ceramic liner 64 and the base 34 of the combustion chamber 24. The condensate channel 65 is in fluid communication with a condensate line 67, which connects the condensate channel 65 to the condensation trap 28, through an aperture 69 in the side 16. The combustion fan 38 is located in the mouth 26 of the combustion chamber 24. A gas valve 94 controls the flow of gas to the burner 22 via a gas line 20.

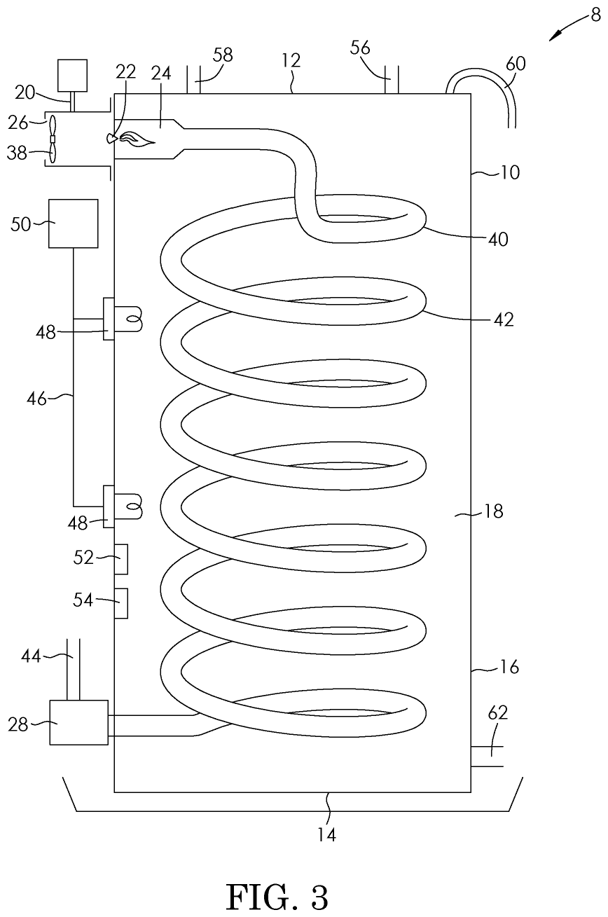

In an alternative embodiment, shown in FIG. 3, the tank 10 has a top 12, a bottom 14, and a cylindrical side wall 16, all which define an interior 18. A gas line 20, which may carry natural gas or propane or the like, provides fuel to a burner 22. The burner 22 is housed in a combustion chamber 24 which is in the vicinity of the top 12 of the tank 10. Proximate the bottom 14, outside of the tank 10 and in fluid communication with the combustion chamber 24 is a condensation trap 28. The condensation trap 28 may be extended via a pipe to the floor pan. A combustion fan 38 is located proximate the burner 22 to provide combustion air from the ambient to the burner 22. The combustion fan 38 is in gaseous communication with the combustion chamber 24 and is located at the combustion chamber mouth 26. The combustion chamber 24 is in gaseous communication with the flue 40. Thus, when the combustion fan 38 is operational, it forces air into the combustion chamber 24 and urges the flue gases through the flue 40. The placement and pushing the flue gases rather than pulling them reduces the chance of condensation within the flue 40. The combustion fan 38 acts as a shutter, thus when it is not operational, it covers the combustion chamber mouth 26 and reduces or eliminates gravity feed of cold, outside air into the building in which the hot water tank 8 is housed. The combustion chamber 24 is shown extending into the interior 18 from the side wall 16 in this embodiment.

The flue 40 is formed into a spiral 42 (helical coil, helix) which extends from the combustion chamber 24 down through the interior 18 of the tank 10, reaching a chimney 44 in the side 16 proximate the bottom 14. The condensation trap 28 is in line with the flue 40 and the chimney 44. There is no vertically disposed flue, nor is there vertically disposed combustion chamber 24 extending substantially into the interior. Heat from combustion is primarily extracted from the flue 40 as it is urged downward through the spiral flue 40 to the chimney 44.

An electrical line 46 provides power to one or more electrical elements 48 which are housed in the interior 18. The electrical elements 48 are preferably located on the side wall 16 and are spaced apart from one another such that different zones of water in the interior are being heated at the same time, or different times.

A smart controller 50 is in electronic communication with the burner 22, the combustion fan 38, the electrical elements 48, a temperature sensor 52 and a thermostat 54.

Water enters the hot water tank 10 through an inlet 56 in the top 12 of the tank 10. Hot water leaves the tank 10 through an outlet 58 in the top 12 of the hot water tank 10. A safety valve 60 is also located in the top 12 of the tank 10. A drain 62 is located either in the bottom 14 or proximate the bottom 14 of the tank 10.

The flue 40 is about 2 inches in inside diameter. This is half the diameter of a standard flue, thus the surface area per inch of length of flue 40 is 12.57 square inches versus 37.7 square inches, however, the ratio of surface area to volume per inch of length of flue is about 4 for the flue 40 compared to about 3 for a standard flue. The flue 40 is about 38 feet long as compared to 4 feet long, hence the ratio of surface area to volume is about 2 for the flue 40 versus about 1 for a standard flue. This greatly increases the efficiency of heat transfer between the flue gases and the water in the interior 18 of the tank 10. As the spiral 42 does not conform to the golden ratio, the flue gases have an increased tendency to cavitate and be slowed, thus further increasing the efficiency of heat transfer between the flue gases and the water in the interior 18 of the hot water tank 10. Similarly, as the spiral 42 is not a straight flue, and gases tend to travel in a straight line, the flue gases contact the inner surface of the flue 40 more often, thus increasing the potential for heat transfer.

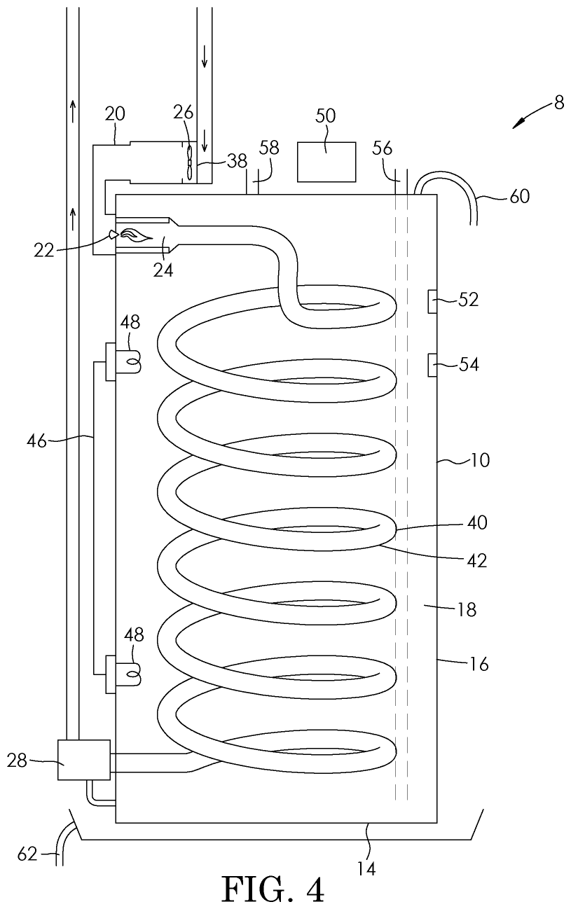

In another alternative embodiment, shown in FIG. 4, the tank 10 has a top 12, a bottom 14, and a cylindrical side wall 16, all which define an interior 18. A gas line 20, which may carry natural gas or propane or the like, provides fuel to a burner 22. The burner 22 is housed in a combustion chamber 24 which is in the vicinity of the top 12 of the tank 10. Proximate the bottom 14, outside of the tank 10 and in fluid communication with the combustion chamber 24 is a condensation trap 28. The condensation trap 28 may be extended via a pipe to the floor pan. A combustion fan 38 is located proximate the burner 22 to provide combustion air from the ambient to the burner 22. The combustion fan 38 is in gaseous communication with the combustion chamber 24 and is located at the combustion chamber mouth 26. The combustion chamber 24 is in gaseous communication with the flue 40. Thus, when the combustion fan 38 is operational, it forces air into the combustion chamber 24 and urges the flue gases through the flue 40. The placement and pushing the flue gases rather than pulling them reduces the chance of condensation within the flue 40. The combustion fan 38 acts as a shutter, thus when it is not operational, it covers the combustion chamber mouth 26 and reduces or eliminates gravity feed of cold, outside air into the building in which the hot water tank 8 is housed. The combustion chamber 24 is shown extending into the interior 18 from the side wall 16 in this embodiment.

The flue 40 is formed into a spiral 42 (helical coil, helix) which extends from the combustion chamber 24 down through the interior 18 of the tank 10, reaching a chimney 44 in the side 16 proximate the bottom 14. The condensation trap 28 is in line with the flue 40 and the chimney 44. There is no vertically disposed flue, nor is there vertically disposed combustion chamber 24 extending substantially into the interior. Heat from combustion is primarily extracted from the flue 40 as it is urged downward through the spiral flue 40 to the chimney 44.

An electrical line 46 provides power to one or more electrical elements 48 which are housed in the interior 18. The electrical elements 48 are preferably located on the side wall 16 and are spaced apart from one another such that different zones of water in the interior are being heated at the same time, or different times.

A smart controller 50 is in electronic communication with the burner 22, the combustion fan 38, the electrical elements 48, a temperature sensor 52 and a thermostat 54.

Water enters the hot water tank 10 through an inlet 56 in the top 12 of the tank 10. Hot water leaves the tank 10 through an outlet 58 in the top 12 of the hot water tank 10. A safety valve 60 is also located in the top 12 of the tank 10. A drain 62 is located either in the bottom 14 or proximate the bottom 14 of the tank 10.

The flue 40 is about 2 inches in inside diameter. This is half the diameter of a standard flue, thus the surface area per inch of length of flue 40 is 12.57 square inches versus 37.7 square inches, however, the ratio of surface area to volume per inch of length of flue is about 4 for the flue 40 compared to about 3 for a standard flue. The flue 40 is about 38 feet long as compared to 4 feet long, hence the ratio of surface area to volume is about 2 for the flue 40 versus about 1 for a standard flue. This greatly increases the efficiency of heat transfer between the flue gases and the water in the interior 18 of the tank 10. As the spiral 42 does not conform to the golden ratio, the flue gases have an increased tendency to cavitate and be slowed, thus further increasing the efficiency of heat transfer between the flue gases and the water in the interior 18 of the hot water tank 10. Similarly, as the spiral 42 is not a straight flue, and gases tend to travel in a straight line, the flue gases contact the inner surface of the flue 40 more often, thus increasing the potential for heat transfer.

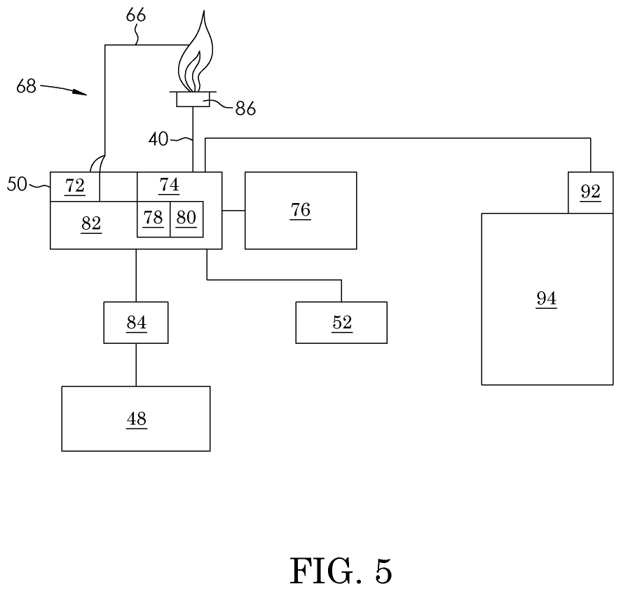

As shown in FIG. 5, a flame ionization sensing element 66 or other suitable sensing element such as for example, but not limited to a thermocouple sensor, is part of a flame sensor system 68, which includes a capacitor 70. The controller 50 includes a printed circuit board 72 and a microprocessor 74 and is in electrical communication with the flame sensor system 68. The microprocessor 74 includes a memory 78, a processor 80 and a wireless communication link 82, which may be, for example, but not limited to Ethernet, WiFi or a Bluetooth® radio or a wired communication link. The printed circuit board 72 and the microprocessor 74 are also in electrical communication with a very rapidly switching, very high duty cycle on off switch 84 that is in electrical communication with the electrical element 48. The switch 84 cycles between on and off between about 30 times a second to about 10,000 times a second. The on off switch 84 is preferably a bidirectional triode thyristor (TRIAC). Switching is either via pulse-width modulation or phase control.

The printed circuit board 72 and the microprocessor 74 are also in electrical communication with an igniter 86 and an actuator 92, which may be a stepper motor, which in turn is in mechanical communication with a variable pressure gas valve 94. The printed circuit board 72 and the microprocessor 74 are also in wired or wireless communication with the thermostat 54.

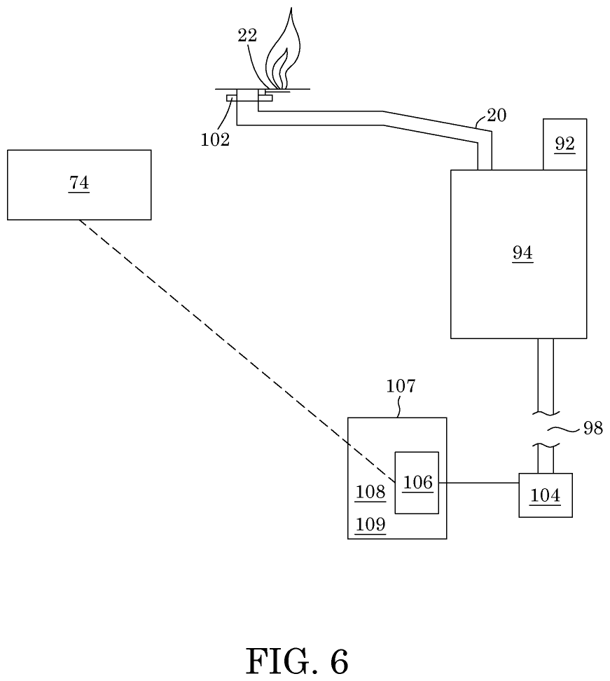

As shown in FIG. 6, the gas valve 94 controls the flow of gas from the main gas supply line 98 through the gas line 20 to a nozzle 102 at the gas burner 22. The main gas supply line 98 is fed from a public gas utility 104. The public gas utility 104 has a wired or a wireless communication link 106, which may be, for example, but not limited to Ethernet, WiFi or a Bluetooth® radio for communicating with the microprocessor 74. The wireless communication link 106 is in a computing device 107, which includes a memory 108 and a processor 109.

If a stepper motor is used as the actuator 92, it can adjust the pressure of the gas at the outlet on the gas valve 94 from about 30% to about 100% in about 0.1% to about 1% increments or about 10% increments. In a preferred embodiment, the actuator 92 is a modulating actuator or a variable position actuator. These may be in communication with a variable current valve 94, which controls the amount of gas and the amount of air being drawn into the gas burner 22. Without being bound to theory, this modulates the thermal output based on feedback from the temperature sensor 52. This is unlike the prior art in which the gas pressure is in steps of low, medium and high, or has an “on” or “off” setting and is not being modulated in response to the actual room temperature.

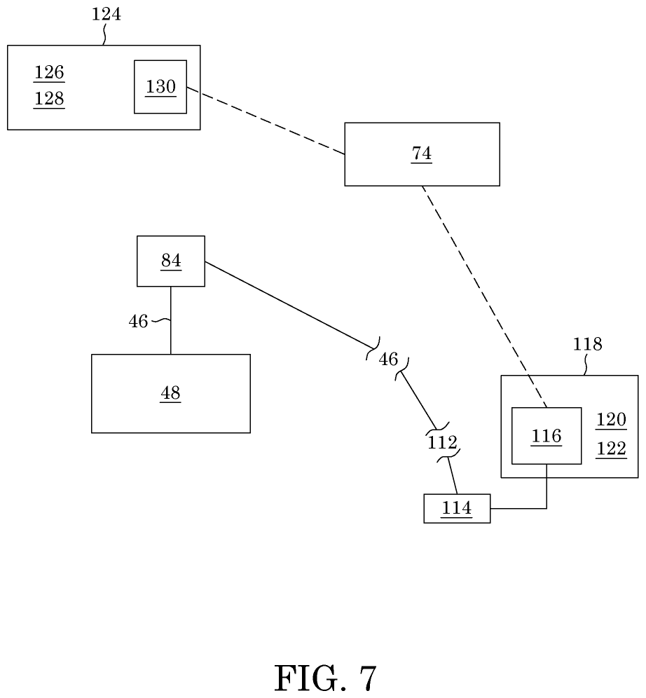

As shown in FIG. 7, the electrical element 48 is connected to the electrical wire 46, which in turn is connected to a power line 112 from a public power utility 114. The on off switch 84 is located along the electrical wire 46. The public power utility 114 has a wired or wireless communication link 116, which may be Ethernet, WiFi or a Bluetooth® radio for communicating with the microprocessor 74. The wireless communication link 116 is in a computing device 118, which includes a memory 120 and a processor 122.

A user also has a computing device 124 with a memory 126, a processor 128 and a wireless communication link 130. The user's computing device 124 may be a desktop, tablet or a cellular phone or other mobile device, as would be known to one skilled in the art. It communicates with the microprocessor 74.

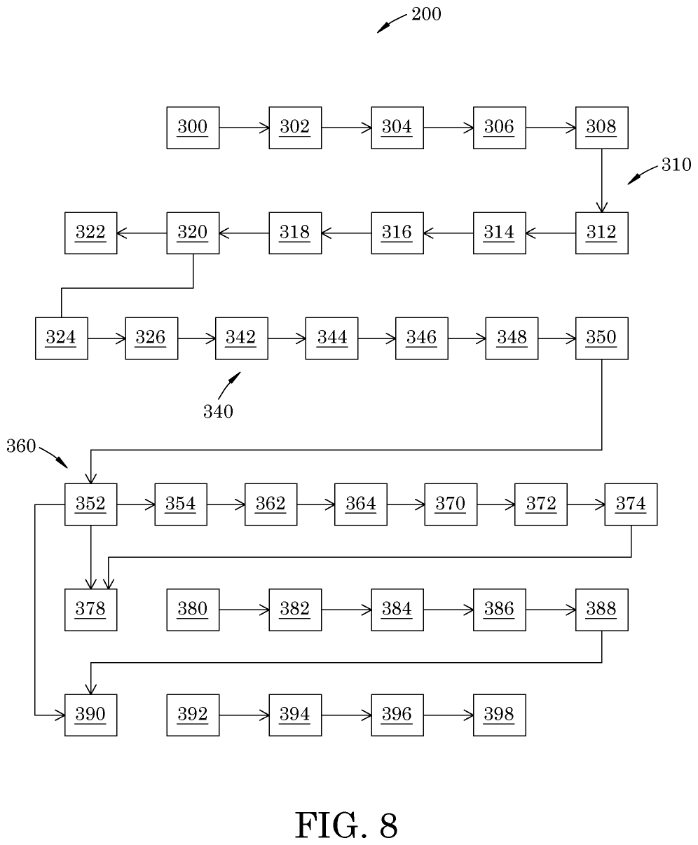

As shown in FIG. 8, one method of operating the hybrid hot water tank is autonomous operation, generally referred to as 200. The temperature is sourced 300 from an internal thermostat or internal temperature sensor. The desired temperature is set 302 in the microprocessor and is usually in the range of 55° C. The microprocessor signals 304 the on off switch to switch on the electrical element. The electrical element begins heating 306. This is the electrical heating mode, generally referred to as 310. Once the element (or elements) reaches about 30,000 for a small tank to about 88,000 British Thermal Units per hour (BTU/h) for a large tank, by way of example only, or the temperature sensor reports 312 a first selected and predetermined temperature increase to the microprocessor, the microprocessor signals 314 the modulating actuator to open 316 the valve to start the flow of gas and the ignitor to ignite 318 the gas. The microprocessor checks 320 the flame ionization sensor system to confirm that the flame is lit. In one mode the microprocessor signals 322 the electrical switch to shut down power to the electrical element, and the heating appliance runs solely on gas up to the maximum BTU of the gas valve. The flame can be maintained at the same height at 15000 BTUs as at 30000 BTU by the microprocessor signaling 324 the combustion fan to alter the air flow to the burner. Alternately, the electric element can be allowed to continue running 326. This is the dual heating mode 340. During this mode, the modulating actuator continues 342 to modulate the gas pressure to modulate the thermal output from the gas burner. This controls the rate of heating, which may be predetermined. Once it reaches a predefined heating rate, for example, about 50,000 BTU/h, or the temperature sensor reports 344 a second selected and predetermined temperature increase to the microprocessor, the microprocessor signals 346 the on off switch to switch off 348 and the electrical element is switched off 350. The microprocessor adjusts 352 the valve to adjust the pressure of the gas at the outlet of the valve and again adjusts the flow of air to the burner by signaling 354 the combustion fan. This controls the rate of heating. This is the gas heating mode, generally referred to as 360. Once it reaches about 60,000 BTU/h, by way of example only, or the temperature sensor reports 362 a third selected and predetermined temperature increase to the processor, the microprocessor may select one of three modes—the electrical heating mode 310, the dual heating mode 340 or the gas heating mode 360. Prior to entering the electrical heating mode 310, the gas burner is shut off by the microprocessor signaling 362 the modulating actuator, which then closes 364 the valve. In the electrical heating mode, the temperature sensor continually reports 370 the temperature to the microprocessor which then signals 372 the on off switch to switch 374 rapidly, for example at about 50 cycles per second, thus maintaining 378 the temperature at a plus or minus 1° C. In the dual heating mode 340 the temperature sensor continually reports 380 the temperature to the microprocessor which then signals 382 the on off switch to switch 384 rapidly, for example at about 50 cycles per second. The microprocessor also signals 386 the modulating actuator which modulates 388 the gas pressure. Both modulate the thermal output thus maintaining 390 the temperature within a predefined range, for example plus or minus 1° C. In the gas heating mode 360, the microprocessor also signals 392 the modulating actuator which modulates 394 the gas pressure, which modulates 396 the thermal output thus maintaining 398 the temperature within a predefined range, for example plus or minus 1° C.

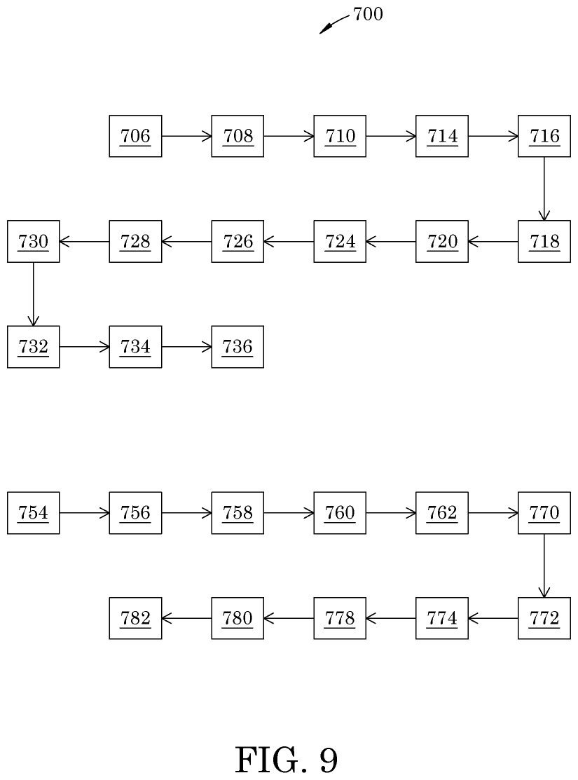

As shown in FIG. 9, a second method of operating the hybrid hot water tank is a utility-controlled operation, generally referred to as 700. The utility selects 706 the heat source. The utility may, for example, instruct 708 their computing device, which then sends 710 a wireless message to the wireless link (or a wired message with a wired link) of the microprocessor to heat using gas. The microprocessor signals 714 the modulating actuator to open 716 the valve to start the flow of gas and the ignitor to ignite 718 the gas. The microprocessor checks 720 the flame ionization sensor system to confirm that the flame is lit. During this mode, the modulating actuator continues 722 to modulate the gas pressure to modulate the thermal output from the gas burner. This controls the rate of heating. The temperature sensor reports 724 the temperature to the microprocessor, which optionally then signals 726 the wireless link (or wired link) to communicate 728 the temperature to the utility's computing device. The microprocessor continues to signal 730 the modulating actuator which modulates 732 the gas pressure. This modulates 734 the thermal output thus maintaining 736 the temperature within a predefined range, for example, plus or minus 1° C.

Alternatively, the utility instructs 754 their computing device, which then sends 756 a wired or wireless message to the wired or wireless link of the microprocessor to heat using electricity. The microprocessor signals 758 the on off switch to switch on 760. The electrical element begins heating 762. The temperature sensor continually reports 770 the temperature to the microprocessor which then signals 772 the on off switch to switch 774 rapidly, for example at about 50 cycles per second, thus maintaining 778 the temperature within a predefined range allowing 780 the temperature to increase at a preselected rate or at a rate which the utility has instructed 782.

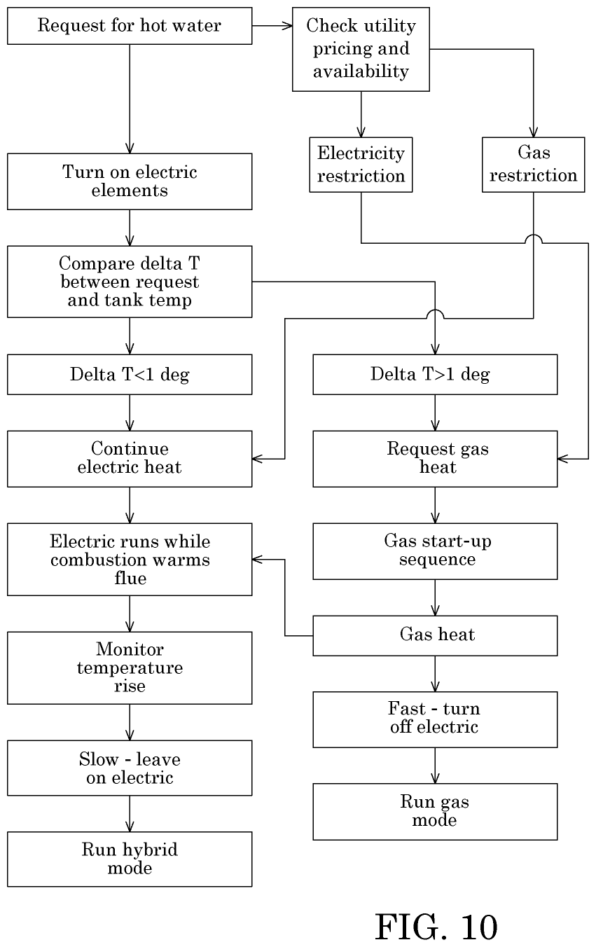

FIG. 10 shows the decision-making process at start up leading to operation in the hybrid mode and in the gas only mode. In one embodiment, the decisions are made locally, under control of a computing device in or proximate the user's residence. In another embodiment, the decisions are made remotely, under control of a computing device in a utility. Both the controller and the utility can independently control both the heat source and the temperature range. Thus, at night, when power costs are lower, the controller or the utility may increase the temperature of the water in the hot water tank to, for example 66° C. The hot water tank then functions as a thermal reservoir over the night and then returns to the normal operating temperature during the day. If needed, a cold water mixing valve may be included as a safety feature to reduce the water temperature back to 55° C., should there be an immediate requirement for hot water before the temperature has returned to the preferred temperature, for example, if a user needs hot water in the middle of the night. Further, the controller and the utility can determine when the cold water that replaces the hot water is heated. Again, for example, should the user use a lot of water around dinner time, the controller or the utility may postpone heating the now cooler water in the hot water tank until in the night, when power costs are lower.

In another embodiment, the flue is a vertically disposed serpentine.

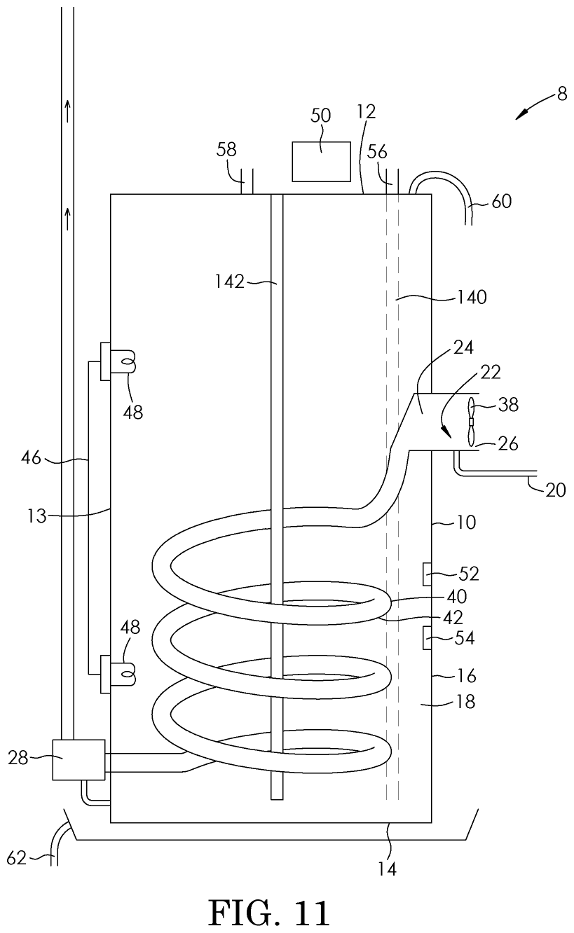

In another alternative embodiment, shown in FIG. 11, the tank 10 has a top 12, a bottom 14, and a cylindrical side wall 16, all which define an interior 18. A gas line 20, which may carry natural gas or propane or the like, provides fuel to a burner 22. The burner 22 is housed in a combustion chamber 24 which is in the vicinity of the middle 13 of the tank 10. Proximate the bottom 14, outside of the tank 10 and in fluid communication with the combustion chamber 24 is a condensation trap 28. The condensation trap 28 may be extended via a pipe to the floor pan. A combustion fan 38 is located proximate the burner 22 to provide combustion air from the ambient to the burner 22. The combustion fan 38 is in gaseous communication with the combustion chamber 24 and is located at the combustion chamber mouth 26. The combustion chamber 24 is in gaseous communication with the flue 40. Thus, when the combustion fan 38 is operational, it forces air into the combustion chamber 24 and urges the flue gases through the flue 40. The placement and pushing the flue gases rather than pulling them reduces the chance of condensation within the flue 40. The combustion fan 38 acts as a shutter, thus when it is not operational, it covers the combustion chamber mouth 26 and reduces or eliminates gravity feed of cold, outside air into the building in which the hot water tank 8 is housed. The combustion chamber 24 is shown extending into the interior 18 from the side wall 16 in this embodiment.

The flue 40 is formed into a spiral 42 (helical coil, helix) which extends from the combustion chamber 24 down through the interior 18 of the tank 10, reaching a chimney 44 in the side 16 proximate the bottom 14. The condensation trap 28 is in line with the flue 40 and the chimney 44. There is no vertically disposed flue, nor is there vertically disposed combustion chamber 24 extending substantially into the interior. Heat from combustion is primarily extracted from the flue 40 as it is urged downward through the spiral flue 40 to the chimney 44.

An electrical line 46 provides power to one or more electrical elements 48 which are housed in the interior 18. The electrical elements 48 are preferably located on the side wall 16 and are spaced apart from one another such that different zones of water in the interior are being heated at the same time, or different times.

A smart controller 50 is in electronic communication with the burner 22, the combustion fan 38, the electrical elements 48, a temperature sensor 52 and a thermostat 54.

Water enters the hot water tank 10 through an inlet 56 in the top 12 of the tank 10 and down through a cold water pipe 110. The cold water pipe 140 is preferably aluminum. A heat conductive bar 142 is located in the interior 18. Hot water leaves the tank 10 through an outlet 58 in the top 12 of the hot water tank 10. In another embodiment, a heat pipe is located in the interior to destabilize the thermal layers of water 18. A safety valve 60 is also located in the top 12 of the tank 10. A drain 62 is located either in the bottom 14 or proximate the bottom 14 of the tank 10.

The flue 40 is about 2 inches in inside diameter. This is half the diameter of a standard flue, thus the surface area per inch of length of flue 40 is 12.57 square inches versus 37.7 square inches, however, the ratio of surface area to volume per inch of length of flue is about 4 for the flue 40 compared to about 3 for a standard flue. The flue 40 is about 38 feet long as compared to 4 feet long, hence the ratio of surface area to volume is about 2 for the flue 40 versus about 1 for a standard flue. This greatly increases the efficiency of heat transfer between the flue gases and the water in the interior 18 of the tank 10. As the spiral 42 does not conform to the golden ratio, the flue gases have an increased tendency to cavitate and be slowed, thus further increasing the efficiency of heat transfer between the flue gases and the water in the interior 18 of the hot water tank 10. Similarly, as the spiral 42 is not a straight flue, and gases tend to travel in a straight line, the flue gases contact the inner surface of the flue 40 more often, thus increasing the potential for heat transfer.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. A hot water tank, the hot water tank comprising: a tank which includes a bottom, a top, and sides therebetween to define an interior; a combustion chamber within the interior, proximate the bottom and sides, the combustion chamber terminating in a mouth where it connects to the side; a gas burner, which is a first heat source and is housed in the combustion chamber; a substantially spiral flue which extends upward through the interior and is in gaseous communication with the combustion chamber and a chimney, which is located proximate the top of the hot water tank, such that in use flue gases travel from the combustion chamber upward to the chimney; and a controller, the controller configured to control the burner.

2. The hot water tank of claim 1 further comprising at least one electrical element which is a second heat source and is housed in the interior and is under control of the controller.

3. The hot water tank of claim 2, further comprising a thermostat and a temperature sensor, the thermostat and temperature sensor in electronic communication with the controller.

4. The hot water tank of claim 3, wherein the controller includes a processor and a memory, the memory configured to modulate the first heat source and the second heat source based on parameters including one or more of a target temperature, a selected rate of heating, a current system load, a cost of a heat source and an availability of the heat source.

5. The hot water tank of claim 4, wherein the processor is configured to switch the first heat source on and off, switch the second heat source on and off and adjust an output of each of the first heat source and the second heat source.

6. (canceled)

7. (canceled)

8. (canceled)

9. A hybrid residential water heating system, the system comprising:
a hot water tank which includes a bottom, a top, and sides therebetween to define an interior; a combustion chamber within the interior, proximate the bottom and sides, the combustion chamber terminating in a mouth where it connects to the side; a gas burner, which is a first heat source and is housed in the combustion chamber; a combustion fan located at the mouth of the combustion chamber and in gaseous communication with an ambient environment and the combustion chamber; a spiral flue which extends through the interior and is in gaseous communication with the combustion chamber and a chimney, which is located proximate the top of the hot water tank, such that in use, flue gases travel from the combustion chamber upward to the chimney; at least one electrical element which is a second heat source and is housed in the interior; a thermostat and a temperature sensor; and
a controller which includes a printed circuit board and a microprocessor wherein the microprocessor is configured to modulate the first heat source and the second heat source and is in electronic communication with the thermostat and the temperature sensor.

10. The hybrid residential water heating system of claim 9, wherein one or more of the printed circuit board and the microprocessor include a wired link or a wireless link.

11. The hybrid hot water tank system of claim 10, further comprising a computing device which includes a wired link or a wireless link and is remote to the hot water tank, the printed circuit board and the microprocessor.

12. The hybrid residential water heating system of claim 11, wherein the computing device is a utilities company computing device.

13. The hybrid residential water heating system of claim 11, wherein the computing device is a third-party systems management company computing device.

14. The hybrid residential water heating system of claim 11, wherein the computing device includes a memory and a processor, the memory configured to instruct the processor to instruct the microprocessor to modulate the first heat source and the second heat source based on parameters including one or more of the target temperature, the selected rate of heating, the current system load, the cost of the heat source and the availability of the heat source.

15. The hybrid residential water heating system of claim 14, wherein the computing device memory is further configured to instruct the processor to determine a cost-effective heating mode and to instruct the microprocessor to modulate the first heat source and the second heat source based on the cost-effective heating mode.

16. (canceled)

17. (canceled)

18. (canceled)

19. A method of heating a domestic water supply, the method comprising:
selecting the hybrid residential water heating system of claim 9; and
modulating the first heat source and the second heat source with the microprocessor based on parameters including a target temperature, a selected rate of heating, a current system load, a cost of a heat source and an availability of the heat source by adjusting a gas flow and an electric current flow.

20. The method of claim 19, further comprising the microprocessor, in any order and in any number of times, switching the first heat source on and off, switching the second heat source on and off and adjusting an output of each of the first heat source and the second heat source.

21. The method of claim 20, further comprising the microprocessor communicating with a remote computing device.

22. The method of claim 21, further comprising the remote computing device instructing the microprocessor to modulate the first heat source and the second heat source based on parameters including one or more of the target temperature, the selected rate of heating, the current system load, the cost of the heat source and the availability of the heat source.

23. The method of claim 22, further comprising the remote computing device determining a cost-effective heating mode and instructing the microprocessor, the microprocessor adjusting the gas flow and the electric current flow such that the first heat source and the second heat source are operating in the cost-effective heating mode.

24. A hybrid hot water tank, the hybrid hot water tank comprising: a tank which includes a bottom, a top, and sides therebetween to define an interior; a combustion chamber within the interior, proximate the bottom and sides, the combustion chamber terminating in a mouth where it connects to the side; a gas burner, which is a first heat source and is housed in the combustion chamber; a combustion fan located at the mouth of the combustion chamber and in gaseous communication with an ambient environment and the combustion chamber; a substantially spiral flue which extends through the interior and is in gaseous communication with the combustion chamber and an externally disposed chimney; a condensation trap, which is outside the tank and is in fluid communication with the combustion chamber or the flue; a controller, the controller configured to control the burner; and at least one electrical element which is a second heat source and is housed in the interior and is under control of the controller, wherein the controller includes a processor and a memory, the memory configured to modulate the first heat source and the second heat source based on parameters including one or more of a target temperature, a selected rate of heating, a current system load, a cost of a heat source and an availability of the heat source.

25. (canceled)

26. (canceled)

27. (canceled)

28. (canceled)

29. (canceled)

30. (canceled)

31. (canceled)

32. (canceled)

33. (canceled)
